(19) United States
(12) Patent Application Publication
(10) Pub. No.: US 2023/0321723 A1
(43) Pub. Date: Oct. 12, 2023

(54) METHOD FOR PRODUCING A 3D SHAPED ARTICLE, AND DEVICE USING A SIEVE PLATE

(71) Applicants: Voxeljet AG, Friedberg (DE); EXENTIS GROUP AG, Stetten (CH)

(72) Inventors: Ingo EDERER, Geltendorf (DE); Alfred GRIESSER, Augsburg (DE); David DECK, Monaco (MC)

(21) Appl. No.: 18/017,226

(22) PCT Filed: Jul. 26, 2021
(86) PCT No.: PCT/DE2021/000123

§ 371 Date: Jan. 20, 2023

(30) Foreign Application Priority Data
Jul. 29, 2020 (DE) 10 2020 004 612.6

(51) Int. Cl. B33Y 10/00; B22F 10/14; B33Y 40/10; B33Y 40/20; B29C 64/165; B29C 64/314; B33Y 30/00

(52) U.S. Cl. CPC B22F 10/14; B29C 64/165; B29C 64/314; B33Y 10/00; B33Y 30/00; B33Y 40/10; B33Y 40/20

(57) ABSTRACT

The invention relates to a method for producing 3D shaped articles, in which method: a suspension comprising metallic, ceramic or polymer particle material or cement-bound materials is applied as a suspension layer to a construction platform to produce a layer; the layer thus applied is at least partially dried; a binder is selectively applied; and the selectively applied binder is solidified; these steps being repeated until the desired 3D shaped article has been obtained; where necessary, the particle material which has not been solidified by means of the binder is removed; and the 3D shaped article is unpacked; wherein the suspension for producing a layer is applied by means of a sieve plate, which is positioned onto the last applied layer on the construction platform and through which the suspension is applied to the last particle material layer; and wherein the sieve plate is removed again before the selective application of the binder.

The invention relates to a method and a device for producing a 3D shaped article using a sieve plate. It relates to the technological field of additive manufacturing, which is also referred to as 3D printing.

### BACKGROUND OF THE DISCLOSURE

In recent years, the demands on the manufacturing industry, especially in the area of design, prototyping, as well as production requirements, have changed dramatically. The increasing number of product variants, with greater complexity, means that the need for prototypes and flexible production processes is constantly growing. Under the generic term “rapid prototyping” or “rapid manufacturing” or “additive manufacturing” (AD) or 3D printing, a plurality of novel technologies have emerged to help meet the demand for more flexible manufacturing and increased quality and production standards.

The essential feature of these processes is the generation of process control data from CAD geometry data with subsequent control of machining equipment. All these methods have the following features in common. Shaping does not occur by material removal, but by addition of material, or by the phase transition of a material from liquid to solid, or compacting of a pulverulent starting material takes place. Furthermore, all methods build on partial geometries of layers of finite thickness, realized by a slice process, directly from CAD data.

The processes available today differ in the initial state of the materials, i.e. solid, liquid or gaseous, in the layer addition or the construction process. Various processes are discussed below.

Binder jetting is an additive manufacturing process for the production of 3D shaped parts in which particle material is applied to a construction platform and bonded at selected locations using selectively applied binder, thereby producing three-dimensional components.

Selective laser sintering (SLS) was originally developed for powders made from nylon, polycarbonate and waxes, and later transferred to metal powders. Here, particle material is also applied to a construction platform and selectively melted by laser.

In multiphase jet solidification (MJS), similar to injection molding, metal powder/binder mixtures are processed through computer-controlled movable nozzles to form layers, which in turn build up the component.

Stereolithography uses liquid UV-sensitive polymers as starting materials, which are cured layer by layer by laser irradiation and deposited on the substrate. The workpiece is successively built up on a platform, which is lowered by the corresponding layer height after the respective layer has cured in the resin bath.

Solid ground curing (SGC) also uses liquid polymers as the starting material. Thin polymer layers cure after exposure to UV radiation at the desired locations, thereby building up a component layer by layer.

Simultaneous shot peening (SSP) is the term used for a process in which an image of the surface of a suitable mold is formed by spraying with liquid metal. This image can serve, for example, as part of an injection mold or a compression mold.

A process very similar to the MJS process is fused deposition modeling (FDM). Here, too, a nozzle is moved under NC control over the height-adjustable workpiece to be built up. The component is built up by cutting off molten material layer by layer and lowering the platform accordingly.

Laminated object manufacturing (LOM) was originally developed for the production of components made of paper or plastic. A laser cuts the corresponding component layers from individual layers, which are laminated together to form the workpiece using adhesives. Likewise, doctor-bladed Al₂O₃ films can be cut and laminated.

According to DE 101 28 664, ceramic shaped articles are formed by sintering selected areas of a ceramic material with a laser beam. The method comprises the steps of: - applying a layer of a liquid suspension or plastic mass, - drying the respectively applied layer, and - sintering the respectively dried layer with the laser beam at selected locations, and is referred to in short as layer-wise slurry deposition (LSD).

In 3D printing, layers of polymeric, metallic or ceramic powders are applied and locally selectively solidified by means of local dosing of a binder in droplet form using a technology comparable to inkjet printing. US 6,596,224 describes a process comparable to this, except that the respective powder layers are not generated as loose powder beds, but by means of slip casting as compact powder layers, which do not have a defined thickness, but are wavy and thus not planar.

EP 2 714 354 B1 describes a method for the production of ceramic shaped articles in which a liquid suspension is applied to a build surface by means of a hollow doctor blade and then dried. The layer is then selectively printed with a binder and the process is repeated until the desired build height is achieved. Finally, the printed areas are freed from the remaining dried material by treatment with a solvent.

One problem with known 3D printing processes is their limited resolution and their quality issues, as well as the problem of a high scrap rate when aiming for high resolution and high production speeds. Particularly in the case of fast application cycles or/and thin application layers, known processes often result in so-called curling or/and simple entrainment or partial entrainment and tearing of the previously applied layer and thus inaccuracies or the unusability of a 3D shaped part produced in this way. Thus, it is difficult to create very thin layers. For example, a hollow doctor blade generates a lot of friction with thin layers and, in the worst case, tears the film.

Another problem with known 3D printing processes is the material properties of the green bodies produced in this way, which differ from those of a conventionally produced green body. Due to this deviation ceramic components whose properties are comparable to a conventionally produced ceramic component can usually be produced only with great technological effort or not at all. An example of this is a ceramic green body produced by stereolithography. This green body is better described as a ceramic-filled polymer with up to 60 vol% of organic matter. The organic matter must be expelled in complex debindering processes before the actual sintering process can begin. Depending on the component geometry, debindering can lead to defects in the green body that generally cannot be eliminated by subsequent sintering.

3D printing results in low-density green bodies due to the low bulk density of the ceramic powders. As a rule, dense ceramics cannot be generated from these green bodies by sintering. Flying powder particles from the loose powder layer repeatedly contaminate the print head during 3D printing and clog the print nozzles. When using very fine ceramic powders, e.g. to increase the sintering activity or to form a particularly fine crystalline structure of the ceramic component, these negative effects are generally intensified.

According to the prior art, suspensions (also called slurries for ceramics) are used to apply powder layers in three-dimensional printing, but they are not applied with a defined layer thickness. With the proposed use of the suspensions, the problem of contamination of the print head by powder particles flying around is eliminated. During the printing process on powder layers, as envisaged in the prior art, loose ceramic particles are repeatedly flung at the print head and clog the print nozzles there.

Furthermore, the proposed method eliminates the problem that very fine particles have a low flowability in the dry state and are therefore no longer suitable for coating above a certain minimum size, or that considerable technological effort must be expended to generate homogeneous layers of ultra-fine powders. Exactly these problems are avoided by the application of a suspension. Fine particles are advantageous, for example, in terms of the surface quality of the prototypes, their sinterability or in the setting of certain particularly fine crystalline microstructures in the ceramic component.

Efforts are also always made to save cost-intensive particle material and to find process solutions that allow reduced particle material use.

In one aspect, therefore, it was an object of the present invention to provide a fast, reliable 3D printing method with good quality characteristics for the production of intermediate products, e.g. green bodies, in ceramic, metallic or polymeric materials.

In another aspect, it was an object of the present invention to provide a 3D printing method with good resolution and high output.

Last but not least, it is an object of the present invention to provide a method in which the density of green bodies obtainable by the proposed method is similar to that of conventionally produced green bodies. This then allows the production of components made of ceramics, metal or other materials, the essential properties of which correspond to those of conventionally produced sintered components without any great technological effort in downstream processes (post-processing).

### SUMMARY OF THE DISCLOSURE

According to the disclosure, the objects underlying the application are achieved by a method for producing a 3D shaped article according to claim 1 and by a device according to claim 9. Advantageous embodiments of the disclosure are the subject of the dependent claims.

### DETAILED DESCRIPTION OF THE DISCLOSURE

In the following, some terms will be defined within the meaning of the disclosure, assuming in all other respects the general understanding of the relevant skilled person.

In the sense of the disclosure, “layer building processes” or “3D printing processes” or “3D processes” or “3D printing”, respectively, are all processes known from the prior art which enable the construction of parts in three-dimensional shapes and are compatible with the process components and device components further described herein.

As used in the disclosure, “binder jetting” means that powder is applied in layers onto a construction platform, one or more liquids is/are printed on the cross-sections of the component on this powder layer, the position of the construction platform is changed by one layer thickness with respect to the previous position, and these steps are repeated until the component is finished. In this context, binder jetting also refers to layering processes that require a further process component such as layer-by-layer exposure, e.g. with IR or UV radiation. Binder jetting is a process known under the generic term additive manufacturing.

A “3D molding”, “shaped article” or “component” in the sense of the disclosure means any three-dimensional object manufactured by means of the method according to the invention or/and the device according to the invention and exhibiting dimensional stability.

“Build area” is the geometric location where the particle material bed grows during the building process by repeated coating with particle material, i.e. by application of suspensions (slurries) or pastes, or through which the bed passes when applying continuous principles. The build area can be bounded by a bottom, i.e. the construction platform, by walls and an open top surface, i.e. the build plane. In continuous principles, there usually are a conveyor belt and limiting side walls. The build area can also be configured in the form of what is called a job box, which constitutes a unit that can be moved in and out of the device and allows batch production, with one job box being moved out after completion of a process to allow a new job box to be moved into the device immediately, thereby increasing both the production volume and, consequently, the performance of the device.

As the “building material” or “particle material” or “powder” or “powder bed” in the sense of the disclosure, all flowable materials and powders known for 3D printing may be used, referred to as slurry, suspension or paste according to the present disclosure.

“Slurry” or “paste” or “suspension” as used in the disclosure may be understood to mean suspensions of one or more particle materials and a carrier liquid.

The particles contained therein may include, for example, metals, ceramic powders, polymers and other powders of inorganic or organic materials, such as plastic materials, fiber materials, as well as other types of organic, pulverulent materials. The particles have typical average particle sizes of 0.5 µm to 50 µm.

The particle material is preferably a free-flowing powder when dry, but a cohesive, cut-resistant powder may also be used. This cohesiveness is adjusted by the addition of a carrier liquid. Said addition results in the particle material being free-flowing in the form of a slurry. In general, particle materials may also be referred to as fluids in the sense of the disclosure.

Carrier liquids are liquids and liquid mixtures that can be mixed with the particle materials to form a suspension. The suspension must be as stable as possible and have an adjusted viscosity and surface tension. The carrier liquid should be easy to dry and the volatile components easy to handle. Water, various alcohols or various oils can be used as carrier fluids without any restriction to generality.

The “particle material application” is the process of generating a defined layer of powder. According to the present disclosure, the particle material is applied as a suspension (slurry) or paste via a sieve plate to the build field or the previously applied particle material layer. This may be done either on the construction platform (build field) or on an inclined plane relative to a conveyor belt in continuous principles. The particle material application will also be referred to below as “recoating”.

“Selective liquid application” or “selective binder application” in the sense of the disclosure may be effected after each particle material application or irregularly, depending on the requirements for the shaped article and for optimization of the molded article production, e.g. several times with respect to particle material application. In this case, a sectional image of the desired article is printed.

The “device” used for carrying out a method according to the disclosure may be any known 3D printing device which includes the required components. According to the disclosure, the device comprises a sieve plate. Further common components include recoater, build field, means for moving the build field or other parts in continuous processes, job box, metering devices and heating and irradiating means and other parts which are known to the person skilled in the art and will therefore not be described in detail herein.

The building material according to the disclosure is always applied in a “defined layer” or “layer thickness”, which is individually adjusted according to the building material and the process conditions. It is, for example, 0.05 to 15 mm, preferably 0.07 to 2 mm.

“Heating means” or “dehumidifying means” as used in the disclosure refers to a means used to dehumidify the suspension after it has been applied. A heating means may be any known heating unit compatible with the other parts of the device, which are known to the person skilled in the art and therefore need not be described in detail here. The heating means is placed in or moved to a suitable position in the device.

“3D printer” or “printer” as used in the disclosure means the device in which a 3D printing process can take place. A 3D printer in the sense of the disclosure comprises a means for applying building material, e.g. a fluid such as a particle material, and a solidification unit, e.g. a print head or an energy input means such as a laser or a heat lamp. Other machine components known to the person skilled in the art and components known in 3D printing are combined with the above-mentioned machine components, depending on the specific requirements in each individual case.

A “build field” is the plane or, in a broader sense, the geometric location on or in which a particle material bed grows during the building process by repeated coating with a suspension or paste through the sieve plate. The build field is frequently bounded by a bottom, i.e. the “construction platform”, by walls and an open top surface, i.e. the build plane.

The process of “printing” or “3D printing” in the sense of the disclosure summarizes the operations of applying material as a suspension or paste using the sieve plate, selective solidification or imprinting and working height adjustment and takes place in an open or closed process chamber.

The “print head” or means for selective solidification in the sense of the disclosure usually consists of various components. Among other things, these can be printing modules. The printing modules have a plurality of nozzles from which the “binder” is ejected as droplets onto the build field in a controlled manner. The printing modules are aligned with respect to the print head. The print head is aligned with respect to the machine. This allows the position of a nozzle to be assigned to the machine coordinate system. The plane in which the nozzles are located is usually referred to as the nozzle plate. Another means of selective solidification can also be one or more lasers or other radiation sources or a heat lamp. Arrays of such radiation sources, such as laser diode arrays, can also be considered. It is possible in the sense of the disclosure to implement selectivity separately from the solidification reaction. Thus, a print head or one or more lasers can be used to selectively treat the layer and other layer treatment means can be used to start the solidification process. In one embodiment, an IR absorber is printed on the particle material, followed by solidification using an infrared source.

A “sieve plate” in the sense of the disclosure is to be understood as a means which is suitable for being arranged on a build field or above or on already applied particle material layers, wherein, in one process step, a particle material is metered as a slurry (suspension) or paste onto the sieve plate and is applied through the sieve plate, e.g. by means of a movable doctor blade device, onto the previously applied particle material layer. The sieve plate can be made of a metal, alloy, wood, fabric or other suitable materials. Sieve plates used in well-known screen printing processes can be applied for this purpose. The sieve plate or the construction platform, respectively, is moved after particle material application so that the applied layer can be dried and then a print head can access the last applied particle material layer and selective binder application can occur. For this purpose, for example, the sieve plate can be moved, e.g. tilted or swung away or moved away from the build field.

The screen fabric of the sieve plate has an opening width suitable to prevent the suspension from passing through due to gravity or capillary action. Typical opening widths are 0.5 - 15 µm, preferably 2 - 10 µm. The fabric thickness of the screen fabric is also of great importance for the process, as it acts like a web, preventing the suspension from being deposited at the points of the web. Typical screen fabrics therefore have a fabric thickness of 5 - 20 µm.

An essential inventive step of one aspect of the disclosure lies in the production of ceramic, as well as metallic and/or polymeric, green layers by a combination of a screen printing process with selective binder printing.

The method and device according to the disclosure are further described below.

In one aspect, the disclosure comprises a method of manufacturing a 3D shaped article (hereinafter also referred to as a shaped article), the method comprising or having the following steps:
forming a 3D shaped article from a particle material by repeatedly performing the following steps:
applying a layer of a suspension comprising one or more particle materials dispersed in a suspension liquid in a working volume, wherein the suspension is applied via a sieve plate.

Dehumidifying or heating or tempering the applied layer in the working volume and
locally applying a binder onto the dried layer and curing the binder in a manner corresponding to a layer model of the shaped article to be produced such that particles in the dried layer are bonded to each other and optionally also to particles of at least one layer located below the dried layer in a locally adhering manner, and
demolding the molded body by removing binder-free residual material from the particles bonded to each other by means of the binder.

According to a further embodiment, a method for manufacturing or producing a shaped article or a green body is disclosed, wherein producing the layer comprises at least partial penetration of a binder into a dried layer of a suspension containing no binder. This offers advantages of lower restrictions in terms of the composition of the suspension applied by means of a sieve plate, since the binder has no influence on the dispersion stability of the suspension. On the other hand, a dried layer with a higher density can be obtained. Segregation during suspension settling can be completely eliminated.

According to a further embodiment, a method for manufacturing or producing a shaped article or an intermediate product or a green body is disclosed, wherein the penetration of the binder is effected by spraying the dried layer with the binder and/or by immersing the dried layer in the binder or in a liquid containing the binder. Advantages of this embodiment result from a wider range of binders that can be used and the possibility to adjust and control the degree of penetration of the dried layer with the binder via the concentration of the binder in its solution.

According to a further embodiment, a method for manufacturing or producing a shaped article or an intermediate product or a green body is disclosed, wherein the cured and/or crosslinked binder is not soluble in the liquid medium. In this way, those portions that have not been solidified by the binder are selectively washed out.

According to a further embodiment, a method for manufacturing or producing a shaped article or a green body is disclosed, wherein the medium comprises water and/or an organic solvent, and wherein the organic solvent is selected from: Acetone, cyclohexane, dioxane, n-hexane, n-octane, toluene, trichloroethanol, dimethyl ethyl ketone, iso-propanol, ethyl alcohol, methyl ethyl ketone, or mixtures obtainable therefrom.

According to a further embodiment, a method for manufacturing or producing a shaped article or a green body is disclosed, wherein a density of the green body is at least 60% of the average material density of a ceramic component of a suspension, if the density of the green body is defined as a quotient of a mass of the green body and a volume computed on the basis of external contours of the green body. In the case of aluminium oxide (Al₂O₃) with a theoretical density of 3.94 g·cm⁻³, this means that Al₂O₃ green bodies built up layer by layer by means of slurry deposition have a density greater than 2.36 g·cm⁻³.

According to a further embodiment, a method for manufacturing or producing a shaped article or an intermediate product, e.g. a green body, is disclosed, wherein the following variants can be used for improved resolution at the interfaces between printed and unprinted areas:

A combination of printed image - generated by the print head and the corresponding binder
with a laser that can scan the interfaces between printed and unprinted areas to improve detail resolution for high-resolution components.

A combination of 2 printing fluids, binder A and fluid B. Binder A is applied in areas where the component is to be formed. In principle, the second printing fluid, fluid B, should be applied in a complementary manner to the binder A. This means that in areas where the primary shaping binder application with binder A has not taken place, a further fluid B is applied for improved detail. Either only the interface between the slurry printed with binder A and the unprinted slurry can be printed with fluid B, or the entire area not printed with the first binder A can be printed. Advantages here can be, in addition to the improvement of detailing, also improved recycling when reprocessing the material not printed with binder A.

According to another aspect of the disclosure, creating the shaped article comprises locally applying a liquid binder that alters the solubility of the particle material aggregate. In this context, the particle material aggregate is understood to be the applied layer of particles or the particle material. This application — locally limited, according to the layer model of the molded article to be produced — of the liquid binder changing the solubility of the particle material causes the solubility of the particle material of the layer to change compared to the solubility of the particles not provided with the binder, or the solubility of the relevant portions of the layer to change. This changes the solubility of the sections of the particle layer intended for the structure of the shaped article itself. During demolding of surrounding particle material, the shaped article is thus formed.

According to another aspect of the disclosure, a device is disclosed for producing a 3D shaped article, said device having the following features:
a largely enclosed working space in which the process of building up the shaped article takes place,
a storage volume configured to receive a suspension of one or more particle materials dispersed in a suspension fluid,
at least one construction platform which is configured to accommodate the desired number of layers and, if necessary, has a machine-readable marking for position recognition,
a receiving means for the at least one construction platform, wherein the receiving means may include a conveyor for the construction platform, the conveyor being adapted to automatically convey the construction platform to different stations in the process flow,
a layer-forming application means configured to repeatedly take an amount of suspension from the storage volume and transfer it to a working volume in order to apply it there as a layer. Said means includes a sieve plate by or using which the suspension is applied onto the building field or the last particle material layer applied, a doctor blade device which applies the suspension through the sieve plate onto the last layer produced, and the necessary movement devices for the sieve plate and the doctor blade.
a dehumidifying means or a heating or temperature control device, respectively, configured to dehumidify the applied layer in the working volume. The dehumidifying means can be located in the process chamber where the layer application also takes place. However, the system can be operated more economically if the processes of layer application and dehumidification can take place separately and simultaneously. For this purpose, the process chamber may have another connected chamber into which a construction platform with a layer just applied is introduced and dried. In the other process chamber with the layer application device, a new layer of a different build process is applied to another construction platform at the same time. In principle, complete spatial separation of the two subprocesses of layer application and dehumidification is also conceivable. In this case, the construction platforms are transported from one process station to the next via suitable conveyor lines. Such a conveyor line could be, for example, a conveyor system that moves the construction platforms in a circle through the individual stations.
a binder-applying means configured to apply a binder locally onto the dehumidified layer in a manner corresponding to a layer model of the shaped article to be produced such that particles in the dehumidified layer are bonded to each other and optionally also to particles of at least one layer located below the dehumidified layer in a locally adhering manner. The binder application means can be in the form of a print head that has a plurality of nozzles and must be moved in a meandering pattern over the build field in order to be able to print it at a defined resolution. It is also conceivable, however, that the print head extends over a side length of the build field and has so many nozzles that it can print the build field in one pass. Ultimately, in this case it is also possible that the print head does not move in the system and the construction platform with the respective build field is passed under the print head. The binder application means can be located in the process process chamber of the layer application means, but it is also possible to separate this process spatially from the other subprocess steps and to couple them via different construction platforms. Here, too, the circular movement of construction platforms through the various process stations is an ideal solution. The registering mark on the construction platform, together with the feed speed of the construction platform, provides a suitable means of accurately positioning and referencing the print image. The binder application means has suitable means for supplying binder, for supplying data, for cleaning the nozzles and for so-called capping — the targeted protection of the nozzles against drying by covering them — during a possible shutdown of the system.
preferably a demolding means configured to demold the shaped article by removing binder-free residual material from the particles bonded to each other by means of the binder. For this purpose, the shaped article, once dried, is exposed to a solvent, preferably an aqueous solution, which dissolves the binding effect of the dried suspension without a binder.

In one aspect, the disclosure comprises the use of a sieve plate by which a suspension comprising particle material is applied and selective solidification is achieved by means of a binder, wherein the sieve plate is moved prior to selective application of the binder and, if necessary, excess suspension is removed from the sieve plate prior to moving it. The selection of the characteristics of the sieve plate thus advantageously makes it possible, on the one hand, to apply very thin layers of advantageous quality and, on the other hand, to achieve further advantages, such as material savings, if necessary, when the suspension application is omitted in areas.

In the disclosed method, the 3D shaped article is produced in a working volume that is shape-free with respect to the external design of the shaped article to be produced by successively applying several layers of a suspension of powder particles dispersed in a suspension liquid. The suspension comprising the powder particles is applied to the previously applied particle layer via a sieve plate, wherein the sieve plate is suitably moved prior to the selective application of the binder to allow the selective application of the binder to proceed unhindered. After application, the applied layer is dried (heated/dehumidified), after which a binder is applied locally to bond the particles in the dried layer to one another in accordance with the layer model of the shaped article to be produced. Optionally, the binder is applied in such a way that the binder spreads not only in the intended areas of the dried layer, but also into one or more underlying layers, so that the currently applied layer is bonded to the underlying layers. The distribution of the binder can be adjusted, for example, by means of the pressure with which the binder is applied to the dried layer. The local (selective) application of the binder is controlled according to an electronic data set for the layer model of the shaped article to be produced. In the layer model, the shaped article to be produced is previously broken down into layers, from which a data set adapted to the manufacturing process is derived for controlling the process. The provision of the layer model is known as such and is therefore not explained further here.

Various aspects and preferred aspects of the disclosure can be described as follows:

In one aspect, the disclosure relates to a method for producing 3D shaped articles, wherein a suspension comprising metallic, ceramic or polymeric particle material or cement-bound materials is applied as a suspension layer to a construction platform to produce a layer, the layer thus applied is at least partially dehumidified, a binder is selectively applied and the selectively applied binder is solidified; these steps being repeated until the desired 3D shaped article has been obtained and, where necessary, the particle material which has not been solidified by means of the binder is removed and the 3D shaped article is unpacked; wherein the suspension for producing a layer is applied by means of a sieve plate, which is positioned onto the last applied layer on the construction platform and through which the suspension is applied to the last particle material layer, and wherein the sieve plate is removed again before the selective application of the binder.

The method described herein may be characterized in that the particle material is deposited on the particle material applied in the previous process step.

The method described herein may be characterized in that further particle materials are added to the suspension, preferably a filler or a second or further particle material to achieve a particle material mixture.

The method described herein may be characterized in that the suspension is applied through the sieve plate with one or more doctor blades.

The method described herein may be characterized in that the metallic particle material is selected from the group consisting of stainless steel, tool steel, aluminum or an aluminum alloy, titanium or a titanium alloy, a chromium-cobalt-molybdenum alloy, a bronze alloy, a precious metal alloy, a nickel-based alloy, and a copper alloy, the ceramic particle material is selected from the group consisting of alumina ceramic, silicate ceramic, zirconia ceramic, the polymeric particle material is selected from the group consisting of methyl methacrylate (MMA), polymethyl methacrylate (PMMA), polyamide 12 (PA12), polypropylene (PP), thermoplastic polyurethane (TPU) and polyether block amide (PEBA).

The method described herein may be characterized in that the thickness of the successively applied suspension layers is 10 to 180 µm.

The method described herein may be characterized in that the obtained particle material layer is 5 to 150 µm.

The method described herein may be characterized in that the suspension comprises an aqueous liquid as solvent.

The method described herein may be characterized in that, after the suspension has been applied, a dehumidification step is carried out by means of hot air or tempering of the build area, preferably at a temperature of 90 to 110° C.

The method described herein may be characterized in that a binder is selectively applied after each or every second or every third application of the suspension.

The method described herein may be characterized by using an organic binder that is not water soluble and/or not soluble in organic solvents after curing.

The method described herein may be characterized in that the binder is suitable for increasing or decreasing the solubility of the selectively printed areas relative to the unprinted areas for a solvent.

The method described herein may be characterized in that the solidification is performed by means of a laser beam, thermal energy input or temperature change.

The method described herein may be characterized in that the binder is solidified via a hot curing process, the binder is cured via a UV curing process, the binder is solidified by cooling through a phase change, the binder reacts chemically or physically with a component in the suspension and is cured, or/and the binder is contained in the suspension and the binder is activated or dissolved or stopped with a printing liquid selectively applied with the print head.

The method described herein may be characterized in that the sieve plate has perforations or is a screen.

The method described herein may be characterized in that, in the method a 3D shaped article is produced as a green body, which is preferably subjected to further process steps, preferably a heat treatment step, more preferably a sintering step.

The method described herein may be characterized in that the process of applying the suspension to a 400 x 400 mm build area takes about 3 to 6 seconds, preferably about 4 seconds.

The method described herein may be characterized in that a laser beam scans the interface between unprinted and printed areas of a layer before or after binder application in order to achieve an even higher level of detail at functional surfaces.

The method described herein may be characterized in that a medium is applied at the interface to the unprinted area or on the complete unprinted area before and/or after the binder application.

The method described herein may be characterized in that the medium is reaction-inhibiting (e.g. an alkaline solution in the case of phenol binders) when combined with the binder or/and particle material or/and a solution; preferably it is an alkaline solution combined with a phenol binder.

In another aspect, the disclosure relates to a device for producing 3D shaped articles comprising a construction platform, one or more sieve plates, a particle suspension material applicator, and at least one print head for selectively applying binder.

The device described herein may further comprise a drying means.

The device described herein may further be characterized in that the construction platform is height-adjustable (Z-axis) or has continuous conveying means, e.g., rollers.

The device described herein may further be characterized in that the one or more sieve plates are movable along the Z-, X- and/or Y-axis.

The device described herein may be further characterized in that the sieve plate consists of or comprises a metal, a fabric, a plastic, or a composite.

The device described herein may further be characterized in that the construction platform is disposed in a build area that is a closed space.

The method or device disclosed herein offers far-reaching advantages over the prior art:

The method using a sieve plate disclosed herein can ensure advantageously clean working. One reason for this is that the paste remains on the sieve when no dosing means, such as a doctor blade (hollow doctor blade) brushes over it. When using a hollow doctor blade, there is a start-stop behavior that leads to unwanted outflow of suspension/particle material/slurry. In addition, slurry always runs off the side as well. When using a sieve plate, coating only takes place where the sieve plate is free, i.e. has openings.

When using a hollow doctor blade, the slurry may possibly dry on the relatively large opening and cause closing of the gap. In the sieve plate used, on the other hand, it is easier to keep the paste moist.

Coating can be carried out very quickly with a sieve plate without compromising the integrity of the layer. For example, a 400 x 400 mm field can be coated in 4 seconds.

Furthermore, the use of a sieve plate allows very precise work and a high quality of the layers can be achieved. A very uniform thin layer can thus be produced. In this way, even very thin layers can be processed and the prior art disadvantage of generating friction and tearing the layers, e.g. when using a gap recoater and producing thin layers, can be avoided.

Another advantage of using a sieve plate is that particle material can be saved. For example, by partially selective application of the layer by a sieve plate, using a sieve plate adapted to a desired part geometry, particle material can be applied only in partial areas by means of a suspension, advantageously resulting in significant saving of material.

Furthermore, it is also advantageously possible to define different process sequences by combining printing technology aspects. For example, a positive printing operation can be performed after coating and intermediate drying, or a negative printing operation can also be performed after coating and drying.

The thickness of the successively applied suspension layers is preferably between about 1 µm and about 200 µm.

After the repeated application of the suspension layers and their processing are completed, the shaped article thus produced is demolded. This means that the particles interconnected by the binder, which form the shaped article, are separated from the binder-free residual material in the working volume. The working volume itself does not determine the shape of the manufactured shaped article. Rather, the outer design of the shaped article is achieved with the aid of the local application of the binder, which ensures the cohesion of the particles after curing.

A preferred further embodiment of the disclosure provides that the binder is applied locally by means of a printing device. The binder is conveniently applied by the printing device with the aid of a suitable print head. Such print heads are known to the skilled person. The printing device is used to realize three-dimensional printing to produce the shaped article.

A convenient embodiment of the disclosure may provide that the applied layer is heated during dehumidification.

An advantageous embodiment of the disclosure may provide that the shaped article is manufactured as a porous shaped article.

Preferably, a further embodiment of the disclosure provides that one or more steps selected from the following group of steps are performed during curing of the binder: air drying, supplying heat, and UV light irradiation. The binder can be cured by air drying alone. In addition or alternatively, heat supply and / or UV light irradiation can be used to cure the binder after application. Alternatively, chemical or physical starter reactions are also possible.

A further embodiment of the disclosure may provide that the demolding is performed at least partially in a liquid bath. The liquid bath may be a water bath, for example. With the aid of the liquid bath, the particles not bound with binder are released from the shaped article.

In a preferred further embodiment of the disclosure, the shaped article is produced with a density of at least 60 vol%, preferably at least 65 vol%, and more preferably at least 70 vol%.

According to a typical embodiment, a method for manufacturing or producing a shaped article or a green body is proposed, wherein a density of the green body is at least 60% of the average material density of a solid component of a suspension, if the density of the green body is defined as a quotient of a mass of the green body and a volume computed on the basis of external contours of the green body. In the case of aluminium oxide (Al₂O₃) with a theoretical density of 3.94 g·cm⁻³, this means that Al₂O₃ green bodies built up layer by layer by means of slurry deposition have a density greater than 2.36 g·cm⁻³.

An advantageous embodiment of the disclosure provides the use of an organic binder that is not water soluble and/or not soluble in organic solvents after curing. This prevents particles from being unintentionally released from the bonded layers during subsequent demolding.

In an advantageous embodiment of the disclosure, it may be provided that the demolded shaped article is sintered. In one embodiment, the organic binder is pyrolyzed during sintering of the shaped article. In this or other embodiments, it may be provided that the shaped article is additionally compacted by the sintering process so that the shaped article is produced with a material density that is greater than the material density of the shaped article after demolding.

In connection with the device for producing the 3D shaped article, it can be provided that the binder-applying means is a printing device by which the binder is applied locally, i.e. selectively, to the previously dried layer, in a manner comparable to the technology of inkjet printing.

Part of the demolding means for demolding the molded article can be a liquid bath in which the binder-free residual particles are detached from the particles bonded together with the aid of the binder.

The layer-forming application means can comprise a conveyor to convey the amount of suspension required for layer formation from the supply volume onto the sieve plate. A doctor blade device may be provided to assist in layer formation.

According to preferred embodiments of the disclosed method, the layer of defined thickness thus obtained has a constant thickness. An essential feature of a layer of defined thickness obtained in this way is that the layer applied in each case has a constant height over its entire extent and is thus characterized in particular by a flat, non-wavy and thus planar surface. Any layer obtained with the sieve plate according to the proposed method is thus characterized by advantageously having a flat, non-wavy surface.

Thus, the shaped article obtained according to the method consists of planar layers throughout and is essentially free of corrugations, since each slurry layer is always applied onto a planar surface. This offers particular advantages for uniform drying and the resulting uniform adhesion of successively superimposed layers, which characterize the shaped article built up layer by layer.

In an exemplary embodiment, the dehumidifying means is formed with a heating means configured to supply heat to the applied suspension layer so that it is dried.

The description of further preferred embodiment examples of the disclosure follows below.

The disclosure is explained in more detail below with reference to preferred embodiment examples. Embodiments of a method for producing a metallic or ceramic shaped article are described, at least some of which can be assigned to rapid prototyping or rapid manufacturing/additive manufacturing.

In the method, the component to be manufactured is first designed in the usual way using a computer program, suitably cut into layers and exported as a data set. With the breakdown into layers, a layer model of the shaped article to be produced is created. The data set contains layer information for the shaped article to be produced.

The layer data is interpreted by a computer of the manufacturing device in order to derive control data therefrom with which the manufacturing device is controlled, in particular initially for forming the thin suspension layers, which in the case of a ceramic material are also referred to as green layers. Suitable ceramic powder materials include, for example, porcelain, Al₂O₃, AIN, SiO₂, Si₃N₄.

The result of the manufacturing process is a prototype that has been produced without a mold, for example a semi-finished product.

The suspension layers are produced using a specially adjusted suspension, which in the case of a suspension of a ceramic material is also referred to as a slurry. Compared to a conventional casting slurry, the suspension here must generally have a higher viscosity with a lower water content. In one possible embodiment of the method, a slurry for series production forms the basis, which only needs to be thickened by increasing the solids content, or can be used directly. Thus, the manufacturing process for the slurry is very cost-effective in this case.

The advantage of using a liquid suspension over the use of powder envisaged in the prior art lies, for example, in the increase in material density, which in the case of a ceramic material is also referred to as green density. In the powder state, the powder particles become electrostatically charged and repel each other, which leads on the one hand to a low bulk density and on the other hand to relatively thick layers. Both effects result in unsatisfactory imaging accuracy.

In the disclosed method, the suspension provided for the production of the shaped article is pressed through a sieve plate by means of a conveyor from a storage or reservoir vessel with the aid of a doctor blade. For this purpose, a manipulator presses the sieve plate onto the last processed layer on which there is a sufficient amount of paste or slurry. To this end, the suspension can be metered, for example, in a line in front of the doctor blade, which is located on a longitudinal side of the sieve. Due to the surface tension, the suspension remains on the sieve plate and does not drip through it. Then the suspension is pressed through the sieve plate by a doctor blade, which is guided over the sieve plate by means of a manipulator. The slurry meets and combines with the previous layer. After the doctor blade has passed over the entire sieve plate, the sieve plate is pulled off the layer. The slurry, which is located between the screen fabric, remains partially on the previous layer and distributes evenly due to gravity and surface forces. A thin layer of defined thickness is formed. The construction platform (plate) can be tempered to facilitate the application of the first layers. The temperature of the construction platform will be below 100° C. at its surface to prevent boiling of the water content in the slurry when using water-based slurries during the application of the first layers. As the number of layers increases, the temperature can be increased significantly, since the already applied layers are very absorbent and initially absorb the moisture of the new layer within fractions of a second. The new layer is thus stabilized and the moisture is evaporated within less than 30 seconds.

In addition to drying from below via the heated plate (construction platform), a radiant heating system in combination with a fan can be used as an alternative or supplement. Additional drying from the top may be necessary if resulting shards have an insulating effect and thus the temperature of the uppermost layers may become too low for sufficiently fast drying (dehumidification) as the thickness of the layer structure increases. The layers that can be produced by this method have a density comparable to conventionally produced green bodies of about 65 vol%.

By means of a print head of a printer device, similar to three-dimensional printing, a binder is selectively applied to the dried layer in droplet form. The binder wets the e.g. ceramic or metallic particles (or optionally other particle materials disclosed herein) and thus penetrates the layer. This penetration of the layer is necessary to bind the desired particles in the layer cross-section and to locally bind the upper layer to deeper layers. The amount of binder applied is such that the binder can penetrate to a desired depth into the article, built up of layers. This depth of penetration of the binder depends on the thickness of a single applied layer and the desired degree of penetration of the binder into deeper layers.

The binder has the properties that it cures after metering, for example by air contact, thermally, using UV light, by 2-phase spraying and / or the like, and is subsequently not soluble or only slightly soluble by other media dissolving the built-up shaped article without binder.

Without the step of thermally or photonically initiated curing/crosslinking, the binder has no or very little binding effect for the powder particles that is insignificant for the process. With its thermally or photonically initiated curing/crosslinking, the binder ensures permanent bonding of the powder particles of the suspension.

In another embodiment, the binder in combination with the particle material of the suspension exhibits a “debinding” effect so that the printed material is more easily released after the application process. It is also conceivable that this debinding effect only relates to the sintering process, which follows after the layer buildup is complete and the printed areas do not sinter in this process step. For this purpose, in this embodiment, the entire layered article including the unprinted area would be sintered in a furnace process. This would have the advantage that the desired components remain embedded in the layer material and cannot bend during the sintering process.

In general, it is also conceivable that the layer is printed with both binding liquid and debinding liquid.

More importantly, the binder can contain further auxiliaries in liquid or solid form, which, for example, promote or prevent sintering or which increase the density or introduce further functionality, such as electrical or thermal conductivity, into the green body.

After the printing process is completed, a new layer is applied by means of a sieve plate with a thickness of, for example, about 1 µm to about 100 µm or thinner and dried, and the printing process starts again. In this way, the shaped article is successively built up layer by layer according to the layer model. After completion of the build-up phase, the shaped article, which now consists of a plurality of layers, is placed in a water bath or other media dissolving the built-up shaped article without binder, and the binder-free areas dissolve. In this way, the shaped article releases a component.

The component generated in this way corresponds in its properties to a conventional green body whose pore volume is partially filled with a binder. If an organic binder is used, the binder is easily expelled when the body is sintered. In the case of an inorganic binder, e.g. in the case of a SiO₂ sol based system, the density of the obtained green body can be even higher than in the case of a conventionally produced ceramic, polymeric or metallic green body.

When using a ceramic particle material, the properties of shaped articles produced in this way correspond to those of a conventional green body whose porosity is partially filled with a binder. The density of the unsintered ceramic green body is higher than in all known generative processes.

For the first time, ceramic or metallic shaped articles can be generated in a generative manufacturing process which, particularly when using the ceramic material, have a density comparable to or even higher than conventionally produced green bodies.

In addition to a higher green density, the material bed (green bed) created by the process proposed here, unlike the powder bed, supports the printed green body. This eliminates the need for prior, time-consuming modeling and the subsequent removal of support structures.

With the disclosed method, green bodies are generated for the first time by means of additive manufacturing that have properties in terms of density and strength comparable to a conventionally produced green body. This allows, in a subsequent sintering step, the preparation of ceramics with properties comparable to ceramics produced in a conventional process.

According to a further embodiment, a method for producing or manufacturing a shaped article or a green body, respectively, is disclosed, wherein the solid fraction of the suspension is selected from a polymer, a metal, a ceramic material or a mixture containing at least a polymer, a metal or a ceramic material. Advantages of this embodiment are the possibility to adjust and vary the properties of the green body and accordingly also the properties of a sintered component, in particular with regard to its electrical conductivity and/or dielectric constant.

A shaped article or green body built up layer by layer by means of slurry deposition typically has a density higher than 60% of the theoretical density of the ceramic or ceramic mixture used. In the case of aluminium oxide (Al₂O₃) with a theoretical density of 3.94 g·cm⁻³, this means that Al₂O₃ green bodies built up layer by layer by means of slurry deposition have a density greater than 2.36 g·cm⁻³.

Although specific embodiments have been shown and described herein, it is within the scope of the present disclosure to suitably modify the embodiments shown without departing from the scope of protection of the present disclosure. The above-described embodiments can be combined with each other as desired. The following claims represent a first, non-binding attempt to define the disclosure in general terms.

1. A method for producing 3D shaped articles, wherein a suspension comprising metallic, ceramic or polymeric particle material or cement-bound materials is applied as a suspension layer to a construction platform to produce a layer, the layer thus applied is at least partially dehumidified, a binder is selectively applied and the selectively applied binder is solidified; these steps being repeated until the desired 3D shaped article has been obtained and, where necessary, the particle material which has not been solidified by means of the binder is removed and the 3D shaped article is unpacked; wherein the suspension for producing a layer is applied by means of a sieve plate, which is positioned onto the last applied layer on the construction platform and through which the suspension is applied to the last particle material layer, and wherein the sieve plate is removed again before the selective application of the binder.

2. The method according to claim 1, wherein the particle material is deposited on the particle material applied in the previous process step, preferably
wherein further particle materials are added to the suspension, preferably a filler or a second or further particle material to achieve a particle material mixture, preferably wherein the suspension is applied through the sieve plate with one or more doctor blades, preferably
wherein the metallic particle material is selected from the group consisting of stainless steel, tool steel, aluminum or an aluminum alloy, titanium or a titanium alloy, a chromium-cobalt-molybdenum alloy, a bronze alloy, a precious metal alloy, a nickel-based alloy, and a copper alloy, the ceramic particle material is selected from the group consisting of alumina ceramic, silicate ceramic, zirconia ceramic, the polymeric particle material is selected from the group consisting of methyl methacrylate (MMA), polymethyl methacrylate (PMMA), polyamide 12 (PA12), polypropylene (PP), thermoplastic polyurethane (TPU) and polyether block amide (PEBA).

3. The method of claim 1, wherein the layer thickness of the successively applied suspension layers is 10 to 180 µm, preferably
wherein the obtained particle material layer is 5 to 150 µm, preferably
wherein the suspension comprises an aqueous liquid as solvent.

4. The method of claim 1, wherein, after the suspension has been applied, a dehumidification step is carried out by means of hot air or tempering of the build area, preferably at a temperature of 90 to 110° C., preferably
wherein a binder is selectively applied after each or every second or every third application of the suspension, preferably
wherein an organic binder is used that is not water soluble and/or not soluble in organic solvents after curing.

5. The method of claim 1, wherein the binder is suitable for increasing or decreasing the solubility of the selectively printed areas relative to the unprinted areas for a solvent, preferably
wherein the solidification is performed by means of a laser beam, thermal energy input or temperature change.

6. The method of claim 1, wherein the binder is solidified via a hot curing process, the binder is cured via a UV curing process, the binder is solidified by cooling through a phase change, the binder reacts chemically or physically with a component in the suspension and is cured, or/and the binder is contained in the suspension and the binder is activated or dissolved or stopped with a printing liquid selectively applied with the print head, preferably
wherein the sieve plate has perforations or is a screen.

7. The method of claim 1, wherein a 3D shaped article is produced as an intermediate product, e.g. as a green body, which is preferably subjected to further process steps, preferably a heat treatment step, more preferably a sintering step, preferably
wherein the process of applying the suspension to a 400 x 400 mm build area takes about 3 to 6 seconds, preferably about 4 seconds, preferably
wherein a laser beam scanning the interface between unprinted and printed areas of a layer before or after binder application.

8. The method of claim 1, wherein a medium is applied at the interface to the unprinted area or on the complete unprinted area before and/or after the binder application, preferably
wherein the medium is reaction-inhibiting (e.g. an alkaline solution in the case of phenol binders) when combined with the binder or/and particle material or/and a solution;
preferably it is an alkaline solution combined with a phenol binder.

9. A device for producing 3D shaped articles comprising a construction platform, one or more sieve plates, a particle suspension material applicator, and at least one print head for selectively applying binder.

10. The device according to claim 9, which further comprises a drying means, preferably
wherein the construction platform is height-adjustable (Z-axis) or has continuous conveying means that, e.g. rollers, preferably
wherein the one or more sieve plates are movable along the Z-, X- and/or Y-axis, preferably
wherein the sieve plate consists of or comprises a metal, a fabric, a plastic, or a composite, preferably
wherein the construction platform is disposed in a build area that is a closed space.

11. The method of claim 2, wherein further particle materials are added to the suspension to achieve a particle material mixture,
wherein the suspension is applied through the sieve plate with one or more doctor blades.

12. The method of claim 11, wherein the metallic particle material is selected from the group consisting of stainless steel, tool steel, aluminum or an aluminum alloy, titanium or a titanium alloy, a chromium-cobalt-molybdenum alloy, a bronze alloy, a precious metal alloy, a nickel-based alloy, and a copper alloy, the ceramic particle material is selected from the group consisting of alumina ceramic, silicate ceramic, zirconia ceramic, the polymeric particle material is selected from the group consisting of methyl methacrylate (MMA), polymethyl methacrylate (PMMA), polyamide 12 (PA12), polypropylene (PP), thermoplastic polyurethane (TPU) and polyether block amide (PEBA).

13. The method of claim 12, wherein the layer thickness of the successively applied suspension layers is 10 to 180 µm, and the suspension comprises an aqueous liquid as solvent.

14. The method of claim 13, wherein, after the suspension has been applied, a dehumidification step is carried out by means of hot air or tempering of the build area, at a temperature of 90 to 110° C., wherein a binder is selectively applied after each or every second or every third application of the suspension.

15. The method of claim 14, wherein the binder is an organic binder that is not water soluble.

16. The method of claim 14, wherein the binder is an organic binder that is not soluble in organic solvents after curing.

17. The method of claim 14, wherein wherein the binder is suitable for increasing or decreasing the solubility of the selectively printed areas relative to the unprinted areas for a solvent,
wherein the solidification is performed by means of a laser beam, thermal energy input or temperature change.

18. The method of claim 14, wherein the binder is solidified via a hot curing process, the binder is cured via a UV curing process, the binder is solidified by cooling through a phase change, the binder reacts chemically or physically with a component in the suspension and is cured, or/and the binder is contained in the suspension and the binder is activated or dissolved or stopped with a printing liquid selectively applied with the print head; and
wherein the sieve plate has perforations or is a screen.

19. The method of claim 18, wherein a 3D shaped article is produced as an intermediate product, e.g. as a green body, which is subjected to further process steps including a sintering step,
wherein the process of applying the suspension to a 400 x 400 mm build area takes about 3 to 6 seconds, preferably about 4 seconds,
wherein the method includes a laser beam scanning the interface between unprinted and printed areas of a layer before or after binder application.

20. The method of claim 18, wherein a medium is applied at the interface to the unprinted area or on the complete unprinted area before and/or after the binder application,
wherein the medium is reaction-inhibiting (e.g. an alkaline solution in the case of phenol binders) when combined with the binder or/and particle material or/and a solution.
